(19) United States
(12) Patent Application Publication
(10) Pub. No.: US 2023/0380510 A1
(43) Pub. Date: Nov. 30, 2023

(54) POWER SELECTION FOR AEROSOL-GENERATING DEVICES

(71) Applicant: PHILIP MORRIS PRODUCTS S.A., Neuchâtel (CH)

(72) Inventor: Gregory André Cristian, Saint-Sulpice (CH)

(21) Appl. No.: 18/029,814

(22) PCT Filed: Oct. 5, 2021
(86) PCT No.: PCT/IB2021/059098

§ 371 Date: Mar. 31, 2023

(30) Foreign Application Priority Data
Oct. 6, 2020 (EP) 20200351.3

(51) Int. Cl. A24F 40/60; A24F 40/20; A24F 40/57; H05B 1/02

(52) U.S. Cl. CPC A24F 40/60; A24F 40/20; A24F 40/57; H05B 1/023

(57) ABSTRACT

Aerosol-generating devices (102) comprising a single power button (152), a heating element (134) to generate aerosol using an aerosol generating article, and a controller (128) comprising one or more processors and operatively coupled to the single power button and the heating element. The controller is configured to provide a plurality of different power levels used with a heating element to generate aerosol using the aerosol-generating device, provide a selected power level of the plurality of different power levels that the aerosol-generating device is presently configured to use with the heating element to generate aerosol, and change the selected power level to a different power level of the plurality of different power levels in response to a user pressing the single power button.

This invention relates to devices, methods and computer program products for adjustment of power used in the generation of aerosol from an aerosol-generating substrate. The power adjustment may be initiated by a user through the use of a single button on an aerosol-generating device and may be indicated using one or more indicators located on the aerosol-generating device.

Adjustment of power settings such as a power output level used to generate aerosol from an aerosol-generating substrate is often cumbersome and time-consuming. For example, users may need to utilize an additional device other than the aerosol-generating device to adjust the power settings on the aerosol-generating device. In one instance, a user may need to utilize a software application, or app, on a user interface device such as a cellular telephone to adjust power settings that must then synchronize and configure the aerosol-generating device over a wired or wireless connection, which may involve many steps, each step providing potential for problems or inefficiency. In another instance, a user may utilize a docking station or charger for the aerosol-generating device to adjust power settings, which may also need to be operatively coupled to the aerosol-generating device to synchronize and configure the aerosol-generating device. Furthermore, when a user is using their aerosol-generating device, such additional devices may not be present (e.g., a user may not have access to their user interface device or docking station) when the user would like change one or more power settings such as power output level. Still further, the required use of additional devices to adjust power settings on an aerosol-generating device may consume additional power (for example, to provide the wired or wireless data transfer to and from the additional device).

A user may accidently or inadvertently make adjustments to various settings such as power settings using prior aerosol-generating devices. For example, such prior aerosol-generating devices do not provide safeguards or techniques to avoid accidental or inadvertent adjustments. In one instance, positionable or rotary switches on prior aerosol-generating devices may be used to select a temperature setting, which may be accidently or inadvertently selected (for example, in a user's pocket) thereby making undesired power output, or temperature, setting changes.

Additionally, some prior aerosol-generating devices do not allow users to change power settings such as power output level, which would not allow users to optimize battery consumption nor allow users to adjust an amount of aerosol generation (for example, “cloud” size, per inhalation or puff).

Still further, aerosol-generating devices for use in generating aerosol may be relatively small so as to be easily carried by users. The small size of the aerosol-generating devices may force the aerosol-generating devices to include a limited amount of display devices and input devices and may limit the size of the battery. Thus, the small size of the aerosol-generating devices may make it challenging for users to adjust power settings such as power output level. Further, larger display devices or more display devices may require more power, which could limit the amount of use between charges for aerosol-generating device, especially when the size of the battery is limited.

More specifically, aerosol-generating devices may need to be very physically small. For example, aerosol-generating devices may be similar in size to only a portion of a conventional cigarette to give a similar sensation to a conventional cigarette in order to gain wide acceptance by smokers of conventional combustible cigarettes. Further, for example, aerosol-generating devices may be a smaller size simply for convenience of users carrying the aerosol-generating devices. Therefore, the hardware on which software can be embedded needs to be very compact and this provides very limited space for a user interface or display devices. Usually, there is space for no more user interface features than one or more user-selectable buttons (for example, depressible buttons, non-depressible buttons such as contact or capacitive switches, etc.) and one or more indicators (for example, lights such as light emitting diode (LED), liquid crystal displays, etc.).

Thus, prior aerosol-generating devices may not provide power settings adjustment, and those prior aerosol-generating devices that do provide power settings adjustment may be time-consuming, cumbersome, power-consuming, and accident prone.

U.S. Pat. No. 10,398,173 describes dual-voltage electronic cigarette control assembly characterized in that the control circuit board is provided with a power managing module, which is configured for alternatively outputting a high preset voltage or a low preset voltage and comprises a boost (step-up) unit, a buck (step-down) unit or a buck-boost unit using a key switch. The key switch may include a one-key switch, where two different stable voltages can be alternatively outputted depending on the times of the key being pressed.

U.S. Pat. No. 8,781,307 describes a rotary or slide switch coupled to a switchable bank of fixed resistors having different resistances to allow incremental adjustment of the output voltage supplied to the heating element.

U.S. Pat. App. Pub. No. 2016/0262459A1 describes that pressing of a “temp set button” (that is revealed by removing the mouthpiece) cycles the temperature setting in firmware, and the new setting is reflected on the LED.

U.S. Pat. App. Pub. No. 2015/0128967A1 describes a vaporizer including a power switch that has two settings: a power off setting and an on power setting, and in another embodiment, the power switch may include several settings, such as a power off setting, a low power setting and a high temperature setting for controlling a temperature of vaporizer.

It would be desirable to provide simple, safeguarded power settings adjustment to aerosol-generating devices without being cumbersome and power-consuming. The present invention may be described as providing simple, safeguarded power settings adjustment to aerosol-generating devices.

According to an aspect of the present invention, there is provided a method for use with an aerosol-generating device comprising providing a plurality of different power levels used with a heating element to generate aerosol using the aerosol-generating device. The method further includes providing a selected power level of the plurality of different power levels that the aerosol-generating device is presently configured to use with the heating element to generate aerosol and changing the selected power level to a different power level of the plurality of different power levels in response to a user pressing a single power button. Further, the user pressing the single power button is or includes the user pressing the single power button a number of times within an engagement time period.

According to an aspect of the present invention, there is provided a computer program product for use with aerosol-generating device comprising a non-transitory computer readable medium having program code stored thereon, the program code configured, when said program product is run on a computer, to provide a plurality of different power levels used with a heating element to generate aerosol. The program product further provides a selected power level of the plurality of different power levels that the aerosol-generating device is presently configured to use with the heating element to generate aerosol and changes the selected power level to a different power level of the plurality of different power levels in response to a user pressing a single power button. Further, the user pressing the single power button is or includes the user pressing the single power button a number of times within an engagement time period.

According to an aspect of the present invention, there is provided an aerosol-generating device comprising a single power button, a heating element to generate aerosol using an aerosol generating article, and a controller comprising one or more processors operatively coupled to the single power button and the heating element. The controller is configured to provide a plurality of different power levels used with a heating element to generate aerosol, provide a selected power level of the plurality of different power levels that the aerosol-generating device is presently configured to use with the heating element to generate aerosol, and change the selected power level to a different power level of the plurality of different power levels in response to a user pressing the single power button. Further, the user pressing the single power button is or includes the user pressing the single power button a number of times within an engagement time period.

The present invention, including the aspects described herein, may provide advantages over the prior devices in that a single power button is utilized thereby making the power settings adjustment less cumbersome and timely to adjust, less costly to manufacture, less complicated, and less accident prone. The use of the single power button simplifies and speeds power settings adjustment. Further, a single press of the single power button may not result in a power settings change (for example, a change in power level) thereby avoiding inadvertent or accidental actuations (for example, when the aerosol-generating device is in a user's pocket). Further, a user need not consult or use an additional device to synchronize or configure the aerosol-generating device since power setting adjustment may be completed by a single power button located on the aerosol-generating device.

Further, the present invention, including the aspects described herein, allow users to optimize battery consumption and allow users to adjust an amount of aerosol generation (for example, “cloud” size, per inhalation or puff). The optimization of battery consumption allows a user to use their aerosol-generating device for longer periods of time away from charging apparatus. Additionally, the adjustment of the amount of aerosol generation allows users to customize their experience to their desires.

Thus, in other words, it may be advantageous for users of aerosol-generating devices (for example, an electronic cigarette) to change the output power level of the aerosol-generating devices to optimize the battery consumption or to change the cloud size generated by the aerosol-generating devices. Further, the ability to change the power level using only the aerosol-generating devices may be described as an “on-device” power setting, which offers the users the capability to change the output power of the aerosol-generating devices without using apps on user interface devices or other devices and without using wired or wireless connectivity (for example, such a USB connection or BLUETOOTH connection).

The engagement time period provides a window of time within which users may select the single power button to initiate, or actuate, a power level change. The engagement time period defines a length sufficient for users to select (for example, touch, depress, indent, move, actuate, etc.) the single power button the required number of times to initiate, or actuate, the power level change. In one aspect, the engagement time period is 2 seconds. In other aspects, the engagement time period is less than 2 seconds such as, for example, 1.5 seconds or 1 second. In other aspects, the engagement time period is greater than 2 seconds such as, for example, 2.5 seconds, 3 seconds, or 5 seconds. Further, it may be described that the engagement time period is 2 or more seconds.

The use of the engagement time period and the required number of times the single power button must be pressed within the engagement time period provides advantages over the prior devices in that the engagement time period safeguards power settings changes from accidental or inadvertent selections (for example, presses) of the single power button. The number of times the single button is pressed when in the engagement time period to initiate a power level change is programmed, or preset, to avoid such accidental or inadvertent selections (for example, presses) of the single power button. button. In one aspect, the required number of times the single button is needed to be pressed within the engagement time period to result in a power settings change is 3. In another aspect, the number of times the single button is pressed when in the engagement time period is 2 In other words, the aerosol-generating device includes “triple-button press” power level change. In other aspects, the number of times the single button is pressed when in the engagement time period is greater than 3 such as 4 or 5.

As described herein, a plurality of different power levels are provided (for example, two or more different levels are provided), each providing a different power level so as to provide a different amount of aerosol generation (over the same time period) when utilized. The aerosol-generating device may be configured or pre-configured with a default power level (for example, selected for the aerosol-generating device when being manufactured). When it is described that a power level of the aerosol-generating device is selected, it is to be understood that such selected power level is the current, or present, power level that the aerosol-generating device is currently, or presently, configured to deliver to the heating element to generate aerosol from an aerosol-generating substrate. The power level may also be described as the power output level for the aerosol-generating device, for example, because the power level is the amount of power output to the heating element, or heater, to generate aerosol from an aerosol-generating substrate.

In one aspect, the plurality of different power levels includes, or comprises, only a first power level and a second power level different from the first power level. In other words, in this aspect, the plurality of different power levels include a high-power level and a low-power level, the low-power level lower than the high-power level. Consequently, the high-power level, when utilized, generates more aerosol over the same period of time than the low-power level. Further, the low-power level, when utilized, consumes less electricity (or battery life) over the same period of time than the high-power level. In other aspects, more than two different power levels are provided such as, for example, 3 different power levels, 5 different power levels, etc.

Each power level may be defined in terms of Wattage or Watts. In one aspect including only two different power levels, the first, or high, power level is 5.5 Watts and the second, or low, power level is 4.5 Watts. In other aspects, the plurality of different power levels may include one or more of 1 Watt, 2 Watts, 2.5 Watts, 3 Watts, 3.5 Watts, 4 Watts, 5 Watts, and 6 Watts.

The aerosol-generating device includes one or more or a plurality of indicators positioned on or part of a housing of the aerosol-generating device. The indicators are configured to display power information to a user such as a level of charge of the battery of the aerosol-generating device and the selected power level which the aerosol-generating device is presently configured as described herein. Preferably, the one or more indicators include a plurality, or two or more, lights such as, for example, light emitting diodes (LEDs). The one or more indicators are configured to emit light according one or more selected characteristics to provide the power information. For example, the one or more selected characteristics may include being on or off, light color, light blinking, light pattern, and combinations thereof. Thus, one or more indicators of the aerosol-generating device are configured to use the one or more selected characteristics to display (and convey) power information to the user.

In one aspect, the one or more indicators indicate, or provide, a present battery level, or level of charge, of the battery of the aerosol-generating device. For instance, the aerosol-generating device may include four indicators and the four indicators, when lit (for example, emitting light), may represent a full-charged battery. When three of the four indicators are lit, the battery is at ¾ charge, when two of the four indicators are lit, the battery is at ½ charge, and when one of the four indicators are lit, the battery is at ¼ charge.

To indicate the present level of charge of the battery, the indicators may be lit (or lighted up) constantly (for example, all the time) or intermittently (for example, part of the time) in response to an action. For instance, the aerosol-generating device may include sensors such as a motion sensor that detects when a user has moved the aerosol-generating device, and in response to such movement, the indicators indicating the present level of charge of the battery may be lit temporarily. Further, for instance, a user may select (for example, touch, depress, indent, move, actuate, etc.) the single power button a single, or one, time to initiate the display of the battery charge level using the indicators. The indicators do not draw very much power, and thus, inadvertent or accidental initiation of the display of the battery charge level would not waste very much power.

In another aspect, the one or more indicators indicate, or provide, a present power level that the aerosol-generating device is configured to heat the aerosol-generating substrate to generate aerosol. For instance, the aerosol-generating device may include four indicators, and when four indicators are lit (for example, emitting light), the present power level may be a high-power level. Further, when two of the four indicators are lit, the present power level may be a low-power level.

To indicate the present power level of the aerosol-generating device, the indicators may be lit (or lighted up) constantly (for example, all the time) or intermittently (for example, part of the time) in response to an action. For instance, the aerosol-generating device may include sensors such as a motion sensor that detects when a user has moved the aerosol-generating device, and in response to such movement, the indicators indicating the present power level of the aerosol-generating device may be lit. Further, for instance, a user may select (for example, touch, depress, indent, move, actuate, etc.) the single power button one or more times to initiate the display of the power level using the indicators. The indicators do not draw very much power, and thus, inadvertent or accidental initiation of the display of the power level of the aerosol-generating device would not waste very much power.

In another aspect, the present power level and a power level change (in response to a user-initiated power level change) may be indicated by the one or more indicators. More specifically, the one or more indicators may display information conveying to a user that the present, or selected, power level has been changed and what the present, or selected, power level now is presently configured on the aerosol-generating device. For instance, in response to a power level change (which, as described herein may be executed by selecting the single power button the required number of times within the engagement time period), one or more indicators may emit, or display, light using a prescribed pattern to indicate that the power level change occurred. In one aspect, two of four indicators are lit (for example, emitting light) and pulse rapidly in a “breathing” fashion to indicate that the power level has changed to the low-power level, and all four indicators are lit (for example, emitting light) and pulse rapidly in a “breathing” fashion to indicate that the power level has changed to the high-power level.

In one aspect, the display of the present power level and the power level change using the indicators may occur or execute over a change time period. Upon expiration of the change time period, the present power level and the power level change will no longer be displayed using the indicators. Further, in one aspect, the battery charge level is re-displayed, or re-indicated, after the change time period expires. The change time period may be between 2 seconds and 10 seconds. In one aspect, the change time period is 3 seconds. In one aspect, the brightness of a first set of the indicators may rapidly increase and subsequently decrease (for example, “breath”) during the change time period indicating the power change to a first power level of the plurality of different power levels, and the brightness of a second set of the indicators may rapidly increase and subsequently decrease (for example, “breath”) during the change time period indicating the power change to a second power level of the plurality of different power levels.

It is advantageous to display the power level of the plurality of different power levels of the aerosol-generating device, the power level changes, and the battery charge level using the same indicators as described herein to reduce complexity, manufacturing cost, and aesthetics of the aerosol-generating device. Thus, the present invention may be described as being an improvement that may utilize existing indicators or displays (for example, LEDs) that were previously only used to show battery charge level (or other information) but now also quickly and accurately convey information related the present power level of the aerosol-generating device and power level changes.

Thus, an illustrative aerosol-generating device may be described as currently having two different power levels and pressing the single power button three times when the power level is 5.5 Watts will change the power level to 4.5 Watts, and conversely, pressing the single power button three times while the power level is 4.5 Watts will change the power level to 5.5 Watts. Further, if the new power level is set to 5.5 Watts, the four indicators (for example, LEDs) will start breathing rapidly for 3 seconds, at the end of the 3 seconds, the indicators go back to indicating the battery level, and if the new power level is 4.5 Watts, the bottom two indicators will start breathing rapidly for 3 seconds, at the end of the 3 seconds, the indicators go back to indicating the battery level.

The aerosol-generating device may define a cavity for receiving the aerosol-generating article and may include a heater configured to heat the aerosol-generating substrate of the article to generate aerosol. The heater may include a blade that is configured to be inserted into an aerosol-generating article to deliver heat to the aerosol-generating substrate of the article. The aerosol-generating device may include a power supply to at least power the heater and may be configured to be interfaced, or operatively coupled, to a host device. The host device may include an interface to be interfaced, or operably coupled, to the aerosol-generating device to at least charge the power supply of the aerosol-generating device.

The aerosol generated from articles that include a tobacco substrate that is heated, but not combusted, contains lower amounts or concentrations of certain smoke constituents than smoke or aerosol produced from combustion and pyrolytic degradation of tobacco in conventional cigarettes. In one known type of aerosol-generating device, an aerosol is generated by the transfer of heat from a heat source to a physically separate aerosol-generating article that includes, for example, a substrate containing tobacco. The device is configured such that the heat source does not combust the substrate. During use, volatile compounds are released from the aerosol-generating substrate by heat transfer from the heat source and entrained in air drawn through the aerosol-generating article. As the released compounds cool, they condense to form an aerosol that is inhaled by the user.

The aerosol-generating device may include a controller comprising one or more processors and a communication interface to transfer data to and from other devices such as a user interface device. For example, a wireless communication interface such as a BLUETOOTH wireless protocol interface may be used between the aerosol-generating device and other devices. The controller may include one or more processors (for example, microprocessors) that may operate with associated data storage, or memory, for access to processing programs or routines and one or more types of data that may be employed to carry out the illustrative methods. For example, processing programs or routines stored in data storage may include programs or routines for checking or determining the present charge level of the battery, indicating the present charge level of the battery using the indicators, maintaining or providing a selected power level used to generate aerosol using the heater, changing the selected power level in response to user action, displaying or indicating a power level change using the indicators, displaying or indicating the present selected power level used to generate aerosol using the heater, performing self-diagnostics, statistics, matrix mathematics, compression algorithms (for example, data compression algorithms), standardization algorithms, comparison algorithms, or any other processing used to implement the one or more illustrative methods and processes described herein.

In one or more embodiments, the aerosol-generating device may be described as being implemented using one or more computer programs executed on one or more programmable processors that include processing capabilities (for example, microcontrollers, programmable logic devices, etc.), data storage (for example, volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

The computer program products used to implement the processes described herein may be provided using any programmable language, for example, a high-level procedural and/or object orientated programming language that is suitable for communicating with a computer system. Any such program products may, for example, be stored on any suitable device, for example, a storage media, readable by a general or special purpose program, controller apparatus for configuring and operating the computer when the suitable device is read for performing the procedures described herein. In other words, at least in one embodiment, the user interface device may be implemented using a non-transitory computer readable storage medium, configured with a computer program, where the storage medium so configured causes the computer to operate in a specific and predefined manner to perform functions described herein.

The exact configuration of the controller of the aerosol-generating device is not limiting and essentially any device capable of providing suitable computing capabilities and control capabilities to implement the illustrative methods described herein may be used. In view of the above, it will be readily apparent that the functionality as described in one or more embodiments according to the present invention may be implemented in any manner as would be known to one skilled in the art. As such, the computer language, the controller, or any other software/hardware which is to be used to implement the processes described herein shall not be limiting on the scope of the systems, processes or programs (for example, the functionality provided by such processes or programs) described herein. The methods and processes described in this disclosure, including those attributed to the apparatus, or various constituent components, may be implemented, at least in part, in hardware, software, firmware, or any combination thereof. For example, various aspects of the techniques may be implemented within one or more processors, including one or more microprocessors, DSPs, ASICs, FPGAs, CPLDs, microcontrollers, or any other equivalent integrated or discrete logic circuitry, as well as any combinations of such components. When implemented in software, the functionality ascribed to the systems, devices, and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors to support one or more aspects of the functionality described in this disclosure.

The term “controller” and “processor” refers to any device or apparatus capable of providing suitable computing capabilities and control capabilities such as, for example, microprocessors, digital signal processors (DSP), application specific integrated circuits (ASIC), field-programmable gate arrays (FPGA), equivalent discrete or integrated logic circuitry, or any combination thereof and of providing suitable data storage capabilities that includes any medium (for example, volatile or non-volatile memory, a CD-ROM, magnetic recordable medium such as a disk or tape, etc.) containing digital bits (for example, encoded in binary, trinary, etc.) that may be readable and/or writeable.

The term “communication interface” refers to any device or apparatus capable of providing suitable data communication capabilities between an aerosol-generating device, a host device, and a user interface device such as, for example, physical data couplings (for example, each may include at least one data interface port for communication of data that may be mated to each other when the aerosol-generating device is received by the host device), various telemetry circuits and antennas and may use one or more wired or wireless (for example, radio frequency) data transmission protocols such as, for example, BLUETOOTH, WI-FI, any protocol in the ultra-high frequency (UHF) band, any protocol in the super high frequency (SHF) band, low frequencies, or combinations thereof.

As described herein, the illustrative aerosol-generating devices include one or more user-selectable buttons such as a single power button. The one or more user-selectable buttons may be described as being configured to be selected by a user to perform, or initiate, one or more actions of the aerosol-generating devices. As used herein, a user may select a user-selectable button by touching, clicking, tapping, or swiping the user-selectable switch with a body part such as, for example, a finger. The one or more user-selectable buttons may also be multi-purpose. For example, the one or more user-selectable buttons may perform various actions when selected by a user such as, for instance, powering on the device, displaying the current battery charge level, etc., and a selected pattern may be used by a user to initiate another action separate from the buttons' primary action such as the power level display or selected power level change. More specifically, a user may perform selection of the single, user-selectable button according to a selected pattern, which may trigger, or initiate, a change of the selected power level and display the power level change and the newly-selected power level using the one or more indicators. The selected pattern may be a pattern that would not be normally triggered during typical use of the aerosol-generating device. Further, the selected pattern may be a pattern that would not likely be accidentally triggered when the aerosol-generating apparatus is being carried in a user's pocket. In one example, the selected pattern may include a series of rapid selections of a single, user-selectable button within a selected engagement time period such as, for instance and preferably, three selections within two seconds

The term “aerosol-generating device” refers to a device configured to use, or utilize, an aerosol-generating article that releases volatile compounds to form an aerosol that may be inhaled by a user. The term “aerosol-generating article” refers to an article that comprises a substrate capable of releasing, upon heating, volatile compounds, which may form an aerosol. The aerosols generated from aerosol-generating articles according to the invention may be visible or invisible and may include vapours (for example, fine particles of substances, which are in a gaseous state, that are ordinarily liquid or solid at room temperature) as well as gases and liquid droplets of condensed vapours. A “heated-type aerosol-generating article” is an aerosol-generating article that comprises an aerosol-generating substrate and is configured for use with an aerosol-generating device that is configured to heat, but not combust, the aerosol-generating substrate. One example of a heated-type aerosol-generating article are the IQOS heat sticks, also known as MARLBORO HEATSTICKS, from Phillip Morris International for use in an IQOS, heat not burn, aerosol-generating device, also from Phillip Morris International.

The invention is defined in the claims. However, below there is provided a non-exhaustive list of non-limiting examples. Any one or more of the features of these examples may be combined with any one or more features of another example, embodiment, or aspect described herein.

Example Ex1: A method for use with an aerosol-generating device comprising: providing a plurality of different power levels used with a heating element to generate aerosol using the aerosol-generating device; providing a selected power level of the plurality of different power levels that the aerosol-generating device is presently configured to use with the heating element to generate aerosol; and changing the selected power level to a different power level of the plurality of different power levels in response to a user pressing a single power button.

Example Ex2: Computer program product for use with aerosol-generating device comprising a non-transitory computer readable medium having program code stored thereon, the program code configured, when said program product is run on a computer, to: provide a plurality of different power levels used with a heating element to generate aerosol using the aerosol-generating device; provide a selected power level of the plurality of different power levels that the aerosol-generating device is presently configured to use with the heating element to generate aerosol; and change the selected power level to a different power level of the plurality of different power levels in response to a user pressing a single power button.

Example Ex3: An aerosol-generating device comprising: a single power button; a heating element to generate aerosol using an aerosol generating article; and a controller comprising one or more processors and operatively coupled to the single power button and the heating element, the controller configured to: provide a plurality of different power levels used with a heating element to generate aerosol using the aerosol-generating device; provide a selected power level of the plurality of different power levels that the aerosol-generating device is presently configured to use with the heating element to generate aerosol; and change the selected power level to a different power level of the plurality of different power levels in response to a user pressing the single power button.

Example Ex4: The method, computer program product, or aerosol-generating device as in any one of Ex1 to Ex3, wherein the user pressing the single power button comprises the user pressing the single power button a number of times within an engagement time period.

Example Ex5. The method, computer program product, or aerosol-generating device as in Ex4, wherein the number of times within the engagement time period that the user presses the single power button is 3.

Example Ex6: The method, computer program product, or aerosol-generating device as in any one of Ex4 to Ex5, wherein the engagement time period is 2 seconds.

Example Ex7: The method, computer program product, or aerosol-generating device as in any one of Ex1 to Ex6, wherein the plurality of different power levels comprises only a first power level and a second power level different from the first power level.

Example Ex8: The method, computer program product, or aerosol-generating device as in Ex7, wherein the first power level is 5.5 Watts and the second power level is 4.5 Watts.

Example Ex9: The method, computer program product, or aerosol-generating device as in any one of Ex1 to Ex8, wherein the method further comprises, the program code are further configured to execute, or the controller further configured to execute: indicating a battery charge level using one or more indicators on the aerosol-generating device; indicating a power level change using the one or more indicators on the aerosol-generating device for a change time period after the changing the selected power level to the different power level of the plurality of different power levels in response to the user pressing the single power button; and re-indicating the battery charge level using one or more indicators on the aerosol-generating device after expiration of the change time period.

Example Ex10: The method, computer program product, or aerosol-generating device as in Ex9, wherein indicating the power level change using the one or more indicators on the aerosol-generating device comprises: rapidly increasing and subsequently decreasing the brightness of a first set of the one or more indicators for the change time period indicating the power level change to a first power level of the plurality of different power levels; and rapidly increasing and subsequently decreasing the brightness of a second set of the one or more indicators for the change time period indicating the power level change to a second power level of the plurality of different power levels.

Example Ex11: The method, computer program product, or aerosol-generating device as in any one of Ex9 to Ex10, wherein change time period is 3 seconds.

Reference will now be made to the drawings, which depict one or more aspects described in this disclosure. However, it will be understood that other aspects not depicted in the drawing fall within the scope and spirit of this disclosure. Like numbers used in the figures refer to like components, steps and the like. However, it will be understood that the use of a number to refer to a component in a given figure is not intended to limit the component in another figure labelled with the same number. In addition, the use of different numbers to refer to components in different figures is not intended to indicate that the different numbered components cannot be the same or similar to other numbered components. The schematic drawings are not necessarily to scale and are presented for purposes of illustration and not limitation. The drawings depict one or more aspects described in this disclosure. However, it will be understood that other aspects not depicted in the drawing fall within the scope and spirit of this disclosure.

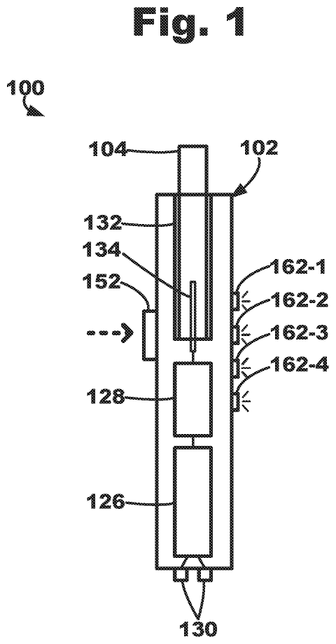

FIG. 1 is a schematic sectional view of an illustrative aerosol-generating apparatus 100 including an aerosol-generating device 102.

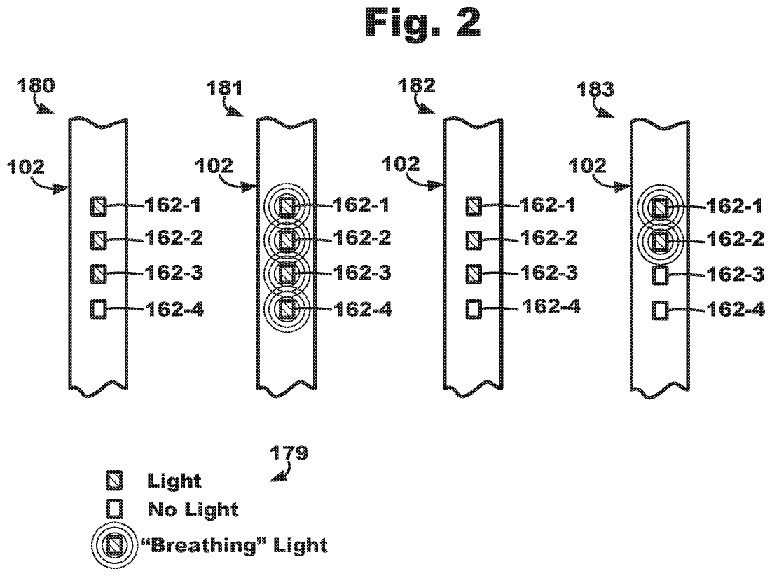

FIG. 2 are views of indicators 162 of the illustrative aerosol-generating device 102 of FIG. 1 for use in providing power level change notifications and the present selected power level.

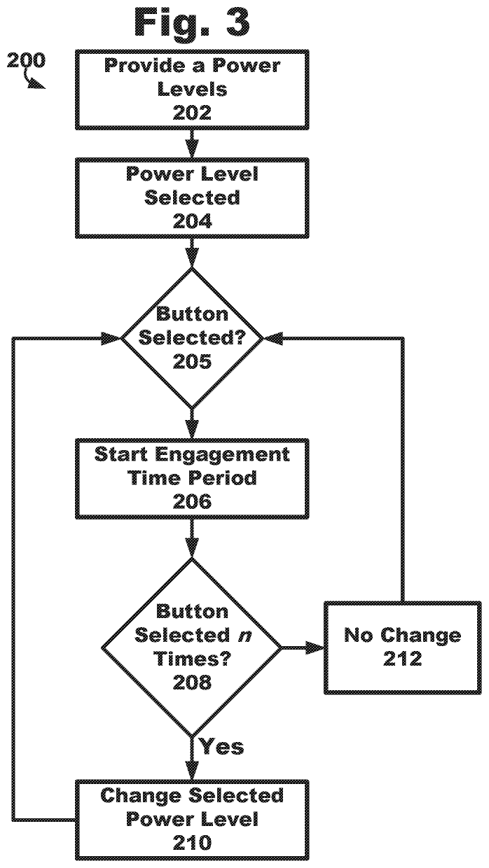

FIG. 3 is a block diagram of an illustrative method of changing the selected power level of the aerosol-generating device 102.

An illustrative aerosol-generating apparatus 100 is depicted in FIG. 1. Preferably, the aerosol-generating apparatus 100 includes an aerosol-generating device 102 comprising a cavity 132 for receiving an aerosol-generating article such as a heat stick 104 and a heater 134, which is configured to provide a source of heat to the heat stick 104 thus producing inhalable aerosol. The aerosol-generating device 102 further includes a controller 128 comprising one or more processors and associated memory. The controller 128 may be associated with the heater 134 so as to, among other things, configure the power level of the heater 134 to generate aerosol when heating an aerosol-generating article. The controller 128 includes, or provides, a selected, or current, power level, which may be stored in memory. Additionally, the controller 128 includes, or provides, other variables related to the power level change process such as an engagement time period, a number of times a user-initiated button is required to be selected with the engagement time period to initiate a power level change, and a change time period. The controller 128 may further include a communication interface such as, for example, a wireless communication interface to, for example, communicate with other devices such as a host device or a user interface device. The communication interface of the controller 128 may preferably comprise a BLUETOOTH interface. The aerosol-generating device 102 further comprises a power supply 126 and power and data and power interface ports 130.

As shown, the aerosol-generating device 102 includes a single user-selectable power button 152 and a plurality of indicators 162-1, 162-2, 162-3, 162-4. The single user-selectable power button 152 may be selectable (for example, depressible) by a user as is indicated by the dashed lined arrow. As described herein, the user-selectable button may be selectable to, among other things, initiate a power level change of the aerosol-generating device 102. For example, if a user depresses the single power button 152 3 times within an engagement time period of 5 seconds, then the aerosol-generating device 102 changes the selected, or current, power level to a different power level of the plurality of different power levels. In an example where the aerosol-generating device 102 has two power levels, a low-power level and a high-power level, initiation, or execution, of a power level change using the single power button 153 will result in the selected, or current, power level switching from the low-power level to the high-power level or from the high-power level to the low-power level, depending on which power level is selected prior the power level change. Although the aerosol-generating device 102 depicted in FIG. 1 includes a single power button 152, it is to be understood that the aerosol-generating device 102 may include a plurality of user-selectable buttons. Nonetheless, in an example where the aerosol-generating device 102 includes a plurality of user-selectable buttons, only one of the user-selectable buttons may be designated as the power button usable by a user to initiate, or execute, power level changes and power level displays. Still further, in one aspect where the aerosol-generating device 102 includes a single button 152 as shown in the FIG. 1, the single button 152 has one or more functions, or uses, beyond power level changes and power level notifications such as, for example, powering “on” or “off” the aerosol-generating device 102 (for example, the aerosol-generating device 102 may be powered “on” or “off” by a “long” selection or press o the button 152).

The plurality of indicators 162-1, 162-2, 162-3, 162-4 may depict a light pattern indicative of, or showing, the charge level of the battery, the selected power level, and the power level change notification or indication. For example, some of the indicators 162-1, 162-2, 162-3, 162-4 may light up a selected color and some of the indicators 162-1, 162-2, 162-3, 162-4 may not light up (stay dark) to indicate the charge level of the battery. Further, example, some of the indicators 162-1, 162-2, 162-3, 162-4 may light up a selected color and varying the brightness thereof while some of the indicators 162-1, 162-2, 162-3, 162-4 may not light up (stay dark) to indicate a power level change and the newly-selected power level.

Pattern examples 180, 181, 182, 183 of the indicators 162 of the illustrative aerosol-generating device 102 of FIG. 1 providing power information are shown in FIG. 2. A key 179 is provided in these figures, which as shown, shows that each of the indicators 162-1, 162-2, 162-3, 162-4 can provide, or display light, no light, and “breathing” light.

As shown in example 180, indicators 162-1, 162-2, 162-3 are displaying, or emitting, light indicating that the battery charge level is currently around 75% of the battery's capacity. When in this state shown in example 180, a user may desire to change the power level of the aerosol-generating device 102, and thus, may select the button 152 the required number of times with an engagement time period to initiate a power level change. Once a user has initiated, or executed, a power level change, each of the indicators 162-1, 162-2, 162-3, 162-4 will display, or emit, light while rapidly increasing and subsequently decreasing the brightness thereof to indicate that the power level has been changed to a high-power level as shown in example 181. The indicators 162-1, 162-2, 162-3, 162-4 will indicate the high-power level for a change time period such as 5 seconds before reverting back to displaying, or indicating, the battery charge level once again as shown in example 182. Once a user has initiated, or executed, a subsequent power level change (that is subsequent to the power level change shown in example 181), the indicators 162-1, 162-2 will display, or emit, light while rapidly increasing and subsequently decreasing the brightness thereof and the indicators 162-3, 162-4 will not light up (stay dark) to indicate that the power level has been changed to a low-power level as shown in example 183.

An illustrative method 200 of changing the selected power level of the aerosol-generating device 102 is depicted in FIG. 3. The method 200 includes providing a plurality of different power levels used with a heating element to generate aerosol 202 and providing a selected power level of the plurality of different power levels 204. The selected power level is the power level that the aerosol-generating device is currently, or presently, configured to utilize when generating aerosol.

In response to the single power button 152 being selected 205, the method 200 may start, or begin, the engagement time period 206, which defines the period of time within which the user may select the single power button 152 so as to actuate, or initiate, a power level change. If the user has selected the single power button 152 the required number, n, times within the engagement time period 208, then the method 200 will change the selected power level 210. Conversely, if the user has not selected the single power button 152 the required number, n, times within the engagement time period 208, then the method 200 will not change the selected power level 212. After either changing or not changing the selected power level, the method 200 will revert to waiting for the initial selection of the single power button 205.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±1% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

All scientific and technical terms used herein have meanings commonly used in the art unless otherwise specified. The definitions provided herein are to facilitate understanding of certain terms used frequently herein. As used herein, the singular forms “a”, “an”, and “the” encompass embodiments having plural referents, unless the content clearly dictates otherwise. As used herein, “or” is generally employed in its sense including “and/or” unless the content clearly dictates otherwise. The term “and/or” means one or all of the listed elements or a combination of any two or more of the listed elements. As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising,” and the like. The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

1-2. (canceled)

3. An aerosol-generating device comprising:
a single power button;
a heating element to generate aerosol using an aerosol generating article; and
a controller comprising one or more processors and operatively coupled to the single power button and the heating element, the controller configured to:
provide a plurality of different power levels used with a heating element to generate aerosol using the aerosol-generating device;
provide a selected power level of the plurality of different power levels that the aerosol-generating device is presently configured to use with the heating element to generate aerosol;
change the selected power level to a different power level of the plurality of different power levels in response to a user pressing the single power button;
indicate a battery charge level using one or more indicators on the aerosol-generating device;
indicate a power level change using the one or more indicators on the aerosol-generating device for a change time period after the changing the selected power level to the different power level of the plurality of different power levels in response to the user pressing the single power button; and
re-indicate the battery charge level using one or more indicators on the aerosol-generating device after expiration of the change time period.

4. The aerosol-generating device of claim 3, wherein the user pressing the single power button comprises the user pressing the single power button a number of times within an engagement time period.

5. The aerosol-generating device of claim 4, wherein the number of times within the engagement time period that the user presses the single power button is 3.

6. The aerosol-generating device of claim 4, wherein the engagement time period is 2 seconds.

7. The aerosol-generating device of claim 3, wherein the plurality of different power levels comprises only a first power level and a second power level different from the first power level.

8. The aerosol-generating device of claim 7, wherein the first power level is 5.5 Watts and the second power level is 4.5 Watts.

9. (canceled)

10. The aerosol-generating device of claim 3, wherein indicating the power level change using the one or more indicators on the aerosol-generating device comprises:
rapidly increasing and subsequently decreasing the brightness of a first set of the one or more indicators for the change time period indicating the power level change to a first power level of the plurality of different power levels; and
rapidly increasing and subsequently decreasing the brightness of a second set of the one or more indicators for the change time period indicating the power level change to a second power level of the plurality of different power levels.

11. The aerosol-generating device of claim 3, wherein change time period is 3 seconds.

12. A method for use with an aerosol-generating device comprising:
providing a plurality of different power levels used with a heating element to generate aerosol using the aerosol-generating device;
providing a selected power level of the plurality of different power levels that the aerosol-generating device is presently configured to use with the heating element to generate aerosol;
changing the selected power level to a different power level of the plurality of different power levels in response to a user pressing a single power button;
indicating a battery charge level using one or more indicators on the aerosol-generating device;
indicating a power level change using the one or more indicators on the aerosol-generating device for a change time period after the changing the selected power level to the different power level of the plurality of different power levels in response to the user pressing the single power button; and
re-indicating the battery charge level using one or more indicators on the aerosol-generating device after expiration of the change time period.

13. The method of claim 12, wherein the user pressing the single power button comprises the user pressing the single power button a number of times within an engagement time period.

14. The method of claim 13, wherein the number of times within the engagement time period that the user presses the single power button is 3.

15. The method of claim 13, wherein the engagement time period is 2 seconds.

16. The method of claim 12, wherein the plurality of different power levels comprises only a first power level and a second power level different from the first power level.

17. The method of claim 16, wherein the first power level is 5.5 Watts and the second power level is 4.5 Watts.

18. The method of claim 12, wherein indicating the power level change using the one or more indicators on the aerosol-generating device comprises:
rapidly increasing and subsequently decreasing the brightness of a first set of the one or more indicators for the change time period indicating the power level change to a first power level of the plurality of different power levels; and
rapidly increasing and subsequently decreasing the brightness of a second set of the one or more indicators for the change time period indicating the power level change to a second power level of the plurality of different power levels.

19. The method of claim 12, wherein change time period is 3 seconds.

20. Computer program product for use with aerosol-generating device comprising a non-transitory computer readable medium having program code stored thereon, the program code configured, when said program product is run on a computer, to:
provide a plurality of different power levels used with a heating element to generate aerosol using the aerosol-generating device;
provide a selected power level of the plurality of different power levels that the aerosol-generating device is presently configured to use with the heating element to generate aerosol;
change the selected power level to a different power level of the plurality of different power levels in response to a user pressing a single power button;
indicate a battery charge level using one or more indicators on the aerosol-generating device;
indicate a power level change using the one or more indicators on the aerosol-generating device for a change time period after the changing the selected power level to the different power level of the plurality of different power levels in response to the user pressing the single power button; and
re-indicate the battery charge level using one or more indicators on the aerosol-generating device after expiration of the change time period.

21. The computer program product of claim 20, wherein the user pressing the single power button comprises the user pressing the single power button a number of times within an engagement time period.

22. The computer program product of claim 20, wherein the plurality of different power levels comprises only a first power level and a second power level different from the first power level.

23. The computer program product of claim 20, wherein indicating the power level change using the one or more indicators on the aerosol-generating device comprises:
rapidly increasing and subsequently decreasing the brightness of a first set of the one or more indicators for the change time period indicating the power level change to a first power level of the plurality of different power levels; and
rapidly increasing and subsequently decreasing the brightness of a second set of the one or more indicators for the change time period indicating the power level change to a second power level of the plurality of different power levels.
